(19) United States
(12) Patent Application Publication
(10) Pub. No.: US 2015/0276119 A1
(43) Pub. Date: Oct. 1, 2015

(54) THREE-DIMENSIONAL PRINTER PLATFORM LEVELING APPARATUS AND METHOD

(71) Applicant: Scott Booker, Oconomowoc, WI (US)

(72) Inventor: Scott Booker, Oconomowoc, WI (US)

(21) Appl. No.: 14/668,459

(22) Filed: Mar. 25, 2015

Related U.S. Application Data
(60) Provisional application No. 61/971,664, filed on Mar. 28, 2014.

(51) Int. Cl. F16M 11/04; B29C 67/00

(52) U.S. Cl. CPC F16M 11/04; B29C 67/0092; B29L 2031/7502

(57) ABSTRACT

The present invention provides a 3D printer comprising a base, a build platform, an adjustable support assembly (e.g., including a resilient support point having a spring and a post) coupling the build platform to the base, and a locking mechanism that secures a position of the build platform relative to the base. The locking mechanism can include a releasable clamp positioned between the base and the post. The present invention also provides a method of tramming a build platform on a 3D printer. The method comprises resiliently supporting the platform on a base at a first support point, pushing on a build surface of the platform at the first support point to move the platform relative to the base, and locking a position of the platform relative to the base at the first support point after the pushing step. Preferably, pushing includes contacting a print head with the build surface.

### FIELD OF THE INVENTION

The present invention relates to three-dimensional (“3D”) printing, and more particularly to an apparatus and method for establishing the proper geometric relationship between a build surface of a 3D printer and the constrained motion axes of a deposition nozzle.

BACKGROUND

3D printing, also called additive manufacturing, involves using a computerized model to make a three-dimensional object in layers using an additive process. As used herein, 3D printing can include any additive process, including selective laser melting (SLM), direct metal laser sintering (DMLS), selective laser sintering (SLS), fused deposition modeling (FDM), and stereolithography (SLA). Fused Deposition Modeling (or Fused Filament Fabrication) is 3D printing process in which a heated head and nozzle system is used to extrude a filament of thermoplastic or similar material, creating a single-layer pattern under numeric control. Subsequent layers are added in sequence and thermally fuse to the underlying layer. By defining and controlling the shape of each layer and the total number of layers, a complete 3D structure can be created or printed.

The 3D printing space is typically defined via the Cartesian coordinate system, with the X and Y axes being horizontal and the Z axis being vertical. The first layer is deposited on a horizontal, planar build surface and subsequent layers are deposited by indexing along the Z axis. The numerically controlled layer pattern is generated in the XY plane by moving the deposition nozzle along that plane relative to the build surface. In practice, this can be done by moving the deposition nozzle in both the X and Y directions, moving the nozzle in one of the X and Y directions and moving the build surface along the other of the X and Y directions, or moving the build surface in both the X and Y directions. Similarly, layers are generated by moving the nozzle along the Z axis relative to the build surface. This can be accomplished by moving the nozzle or the build surface in the Z direction.

In order to properly deposit a first uniform layer and ensure that it mechanically bonds to the build surface, a number of conditions must exist. The build surface must be planar with a high degree of mechanical flatness. Also, the planar build surface must be parallel to the XY motion plane described and defined by the relative motion between the extrusion nozzle and build surface in the X and Y directions. Surface deviations (e.g., warping) along the Z axis or a lack of XY plane parallelism can negatively affect thickness uniformity of the first deposited layer or, in extreme cases, can cause the extruded filament to lose contact with the build surface during first layer generation. First layer pattern generation and build surface adhesion will typically fail if contact is lost.

Tramming is the process of establishing parallelism between the XY motion plane of the nozzle and the build surface. Conventional tramming requires manually and mechanically adjusting the planar attitude of the build surface with multi-point tramming mechanisms, such as jacking screws, cams, and the like. Z-axis measurements are made between the extrusion surface of the nozzle and the build surface as the nozzle is moved within its XY plane. Incremental and sequential mechanical adjustments are made to the tramming mechanisms until the distance along the Z-axis or gap between the build surface and the nozzle is uniform along the XY plane, thus creating the desired parallelism. This process is laborious and time-consuming, requiring precise measurement and adjustment.

### SUMMARY

The present invention provides a 3D printer comprising a base, a build platform supported by the base, an adjustable support assembly coupling the build platform to the base, and a locking mechanism that secures a position of the build platform relative to the base. The adjustable support assembly can include a resilient support point (e.g., three resilient support points) between the base and the platform. For example, the resilient support point can include a compressible resilient member supporting the platform on the base and a post extending between the platform and the base. Preferably, the post includes a pivot to facilitate limited angular movement of the post relative to the platform or the base

In one embodiment, the locking mechanism includes a releasable clamp operatively positioned between the base and the post. For example, the locking mechanism can be movable from an unlocked position, where the platform is movable relative to the base at the support point, and a locked position, where the platform in substantially inhibited from moving relative to the base at the support point.

The present invention also provides a method of tramming a build platform on a 3D printer. The method comprises resiliently supporting the platform on a base at a first support point, pushing on a build surface of the platform substantially at the first support point to move the platform relative to the base, and locking a position of the platform relative to the base at the first support point after the pushing step. Preferably, pushing down includes contacting a print head with the build surface. In this embodiment, the locking step can occur with the print head in contact with the build surface.

In one embodiment of the method, after the recited resiliently supporting, pushing, and locking steps associated with the first support point, these steps are repeated at a second support point while maintaining the locked position of the platform relative to the base at the first support point. The method preferably continues by performing the recited resiliently supporting, pushing and locking steps at a third support point while maintaining the locked position of the platform relative to the base at the first and second support points.

Other features and aspects of the invention will become apparent by consideration of the following detailed description and accompanying drawings.

### BRIEF DESCRIPTION OF THE DRAWINGS

FIG. 1 illustrates a 3D printer on which features of the present invention can be applied.

FIG. 2 is a perspective view of a platform assembly for use in a 3D printer.

FIG. 3 is a partially exploded view of the platform assembly of FIG. 2.

FIG. 4 is a cross-sectional perspective view taken along line 4-4 in FIG. 2.

FIG. 5 is a bottom perspective view of the platform assembly of FIG. 2.

FIG. 6 is a perspective view of a portion of the platform assembly of FIG. 2.

FIG. 7 is a schematic cross-sectional view of the platform assembly of FIG. 2 during an automatic tramming operation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

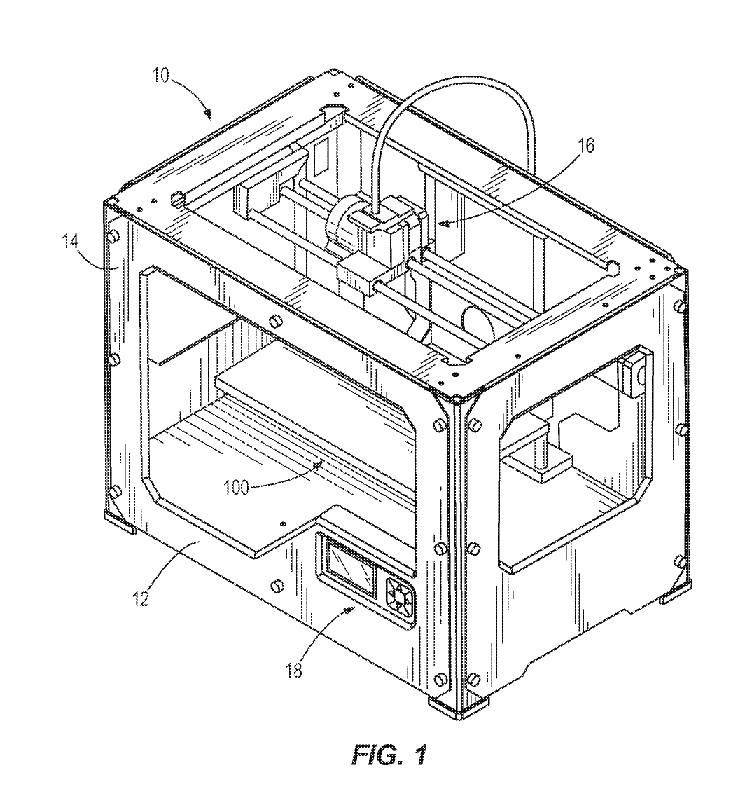

FIG. 1 illustrates a 3D printer 10 including a base 12, a housing 14, a print head 16, a control panel 18, and a platform assembly 100 embodying aspects of the invention. The platform assembly 100 is usable with a variety of different numerically-controlled manufacturing systems, such as the 3D printing systems disclosed in Skubic et al., U.S. Patent Application Publication No. 2010/0100222; and Calderon et al., U.S. Pat. No. 6,629,011, the entire contents of each of which are incorporated herein by reference. Alternatively, the platform assembly 100 may be used with any other type of numerically-controlled manufacturing system, such as a metal injection molding (MIM) system, a computer numerical control (CNC) machining system, and the like.

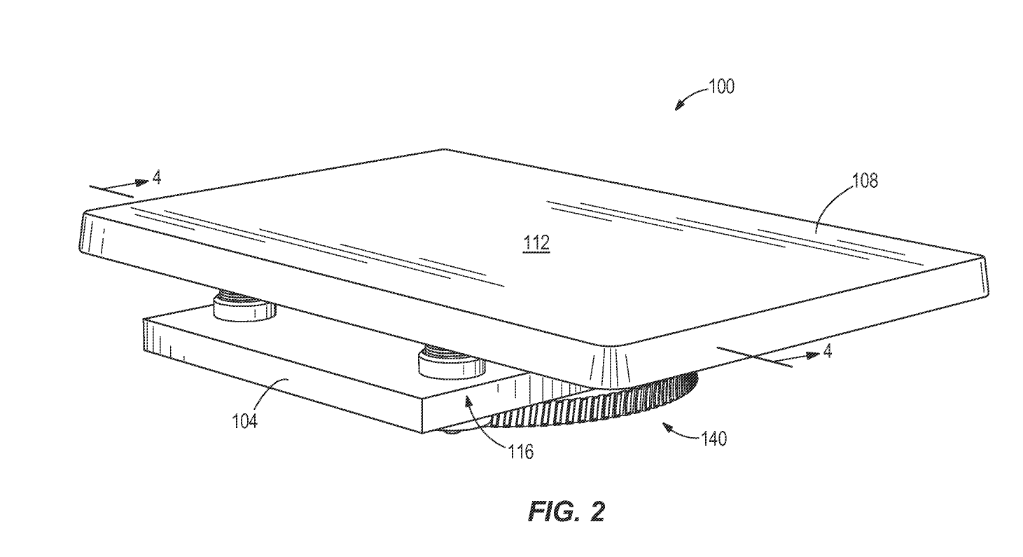

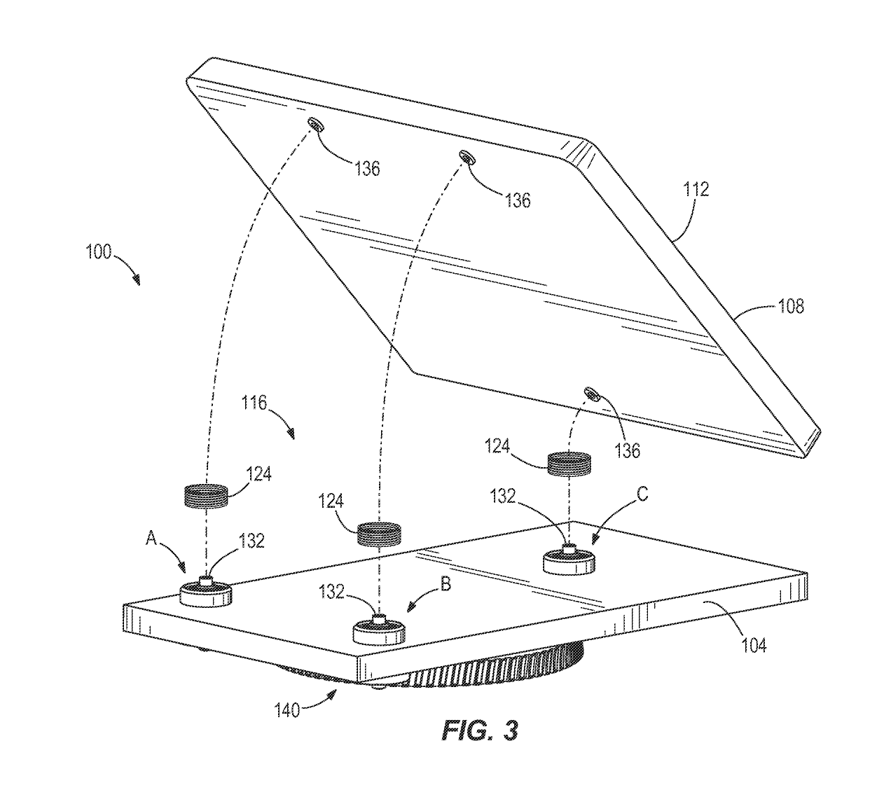

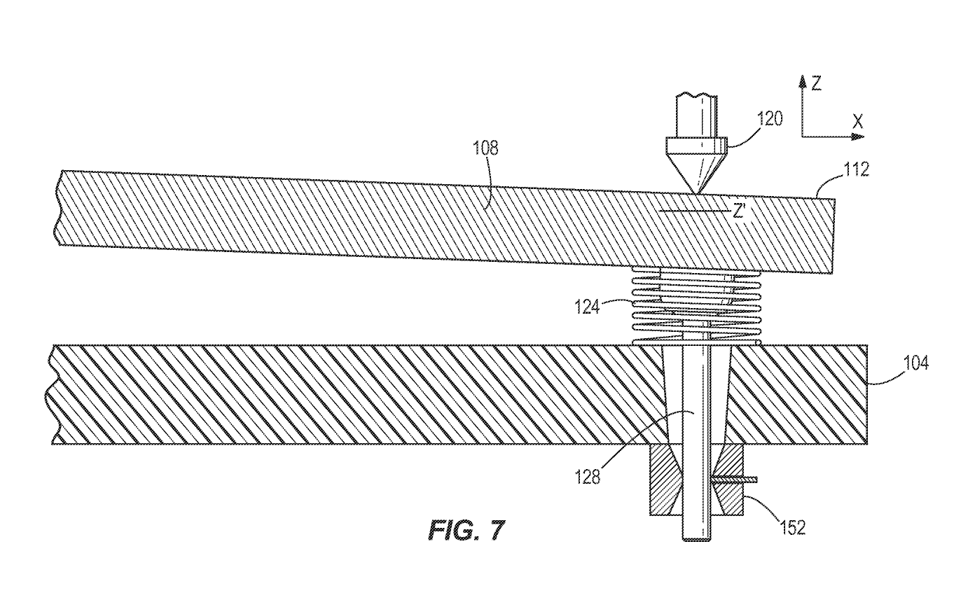

With reference to FIGS. 2 and 3, the platform assembly 100 includes a base 104 and a build platform 108 having a planar build surface 112 on which layers of material can be deposited during a 3D printing operation. The build platform 108 is supported on the base 104 at three points—A, B, and C—by an adjustable support assembly 116. In the illustrated embodiment, the three support points A, B, C are located proximate the outer periphery of the build platform 108 for increased stability; however, the three points A, B, C may be located at other locations on the build platform 108. As described in further detail below, the adjustable support assembly 116 includes automatic tramming functionality that allows the build platform 108 to be leveled relative to the XY motion plane of a deposition nozzle 120 (FIG. 7).

Referring to FIG. 3, the adjustable support assembly includes a spring 124 disposed between the build platform 108 and the base 104 at each of the support points A, B, C such that the build platform 108 can “float” on the springs 124 above the base 104. In the illustrated embodiment, the springs 124 are coil springs having a relatively low spring rate. Alternatively, the springs 124 can be elastomeric washers, Belleville springs, or other compliant structures. When the springs 124 are in their neutral or relatively uncompressed state (i.e., compressed only by the weight of the build platform 108), the build platform 108 floats above the base 104 at a height where the build surface 112 is located above a desired height Z′ of the first layer deposition (FIG. 7). In other words, if Z′=0, the build surface 112 has a positive Z-axis coordinate when the springs 124 are in their neutral state.

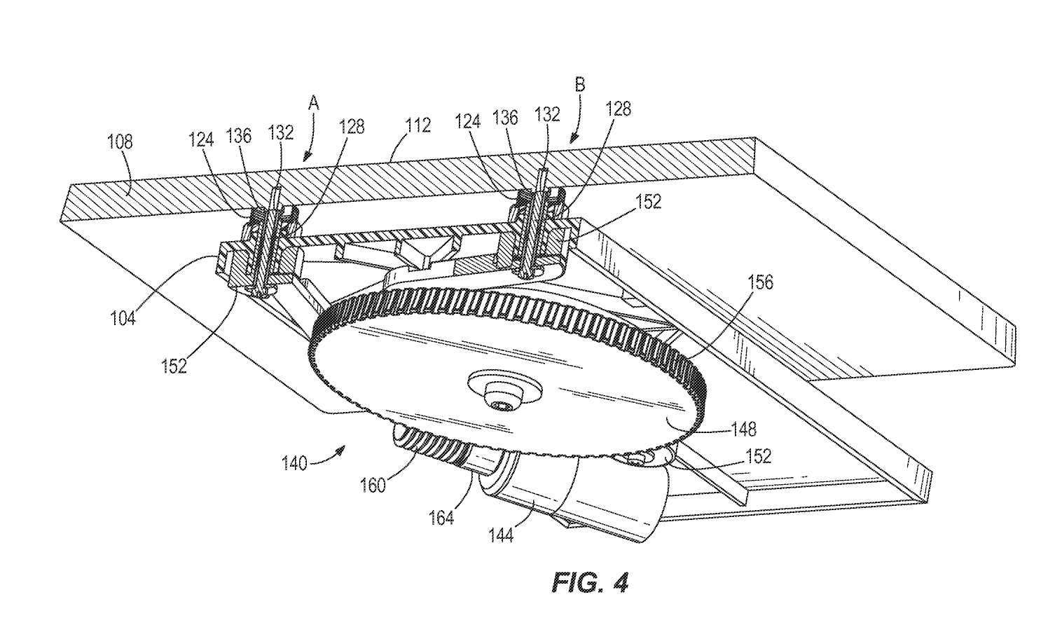

Referring to FIG. 4, the adjustable support assembly 116 further includes a rigid pin 128 extending from the build platform 108 and through an opening in the base 104 at each of the support points A, B, C. An upper end 132 of each pin 128 is received in a corresponding boss 136 on the bottom of the build platform 108 to couple the pins 128 to the build platform 108. In some embodiments, the bosses 136 and the pins 128 have pivot, gimbal, or ball-and-socket capability, allowing for angular deflection of the pins 128 relative to the build platform 108 while still maintaining the relative spacing between the pins 128.

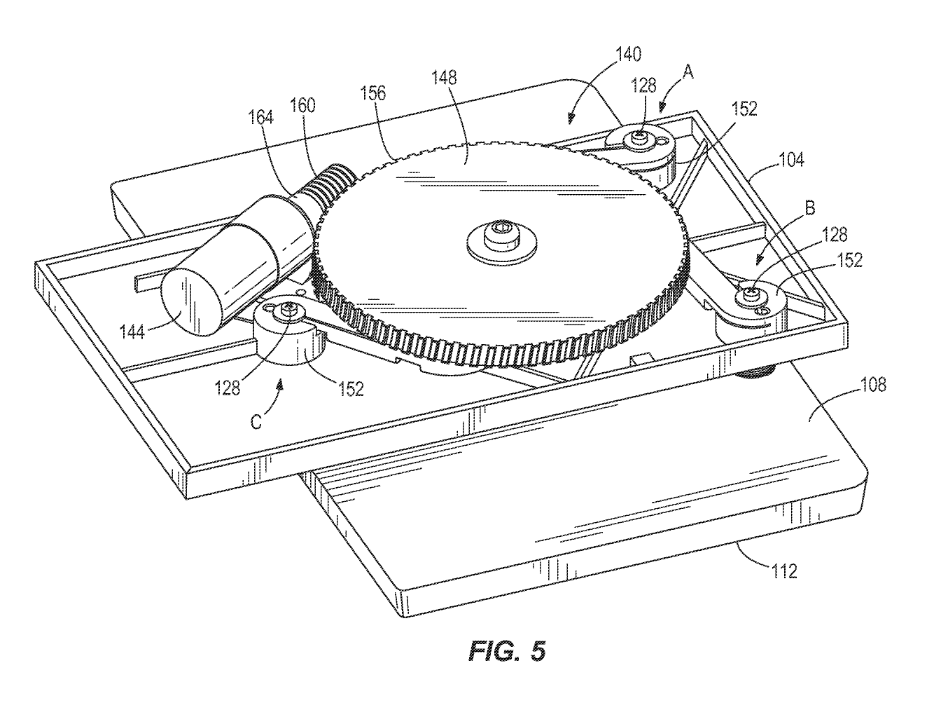

With reference to FIGS. 4-6, the platform assembly 100 further includes a locking mechanism 140 for selectively locking each of the respective pins 128 relative to the base 104, thereby locking the build platform 108 at a desired height and orientation relative to the base 104. In the illustrated embodiment, the locking mechanism 140 includes an electric motor 144, a cam wheel 148, and three clamps 152, each engageable with one of the respective pins 128. The cam wheel 148 is configured as a worm gear and includes a plurality of teeth 156 that engage a worm 160 on an output shaft 164 of the motor 144. Thus, when the motor 144 is energized, the cam wheel 148 rotates relative to the base 104. In some embodiments, the motor 144 may be replaced by a manual crank or other means suitable for rotating the cam wheel 148.

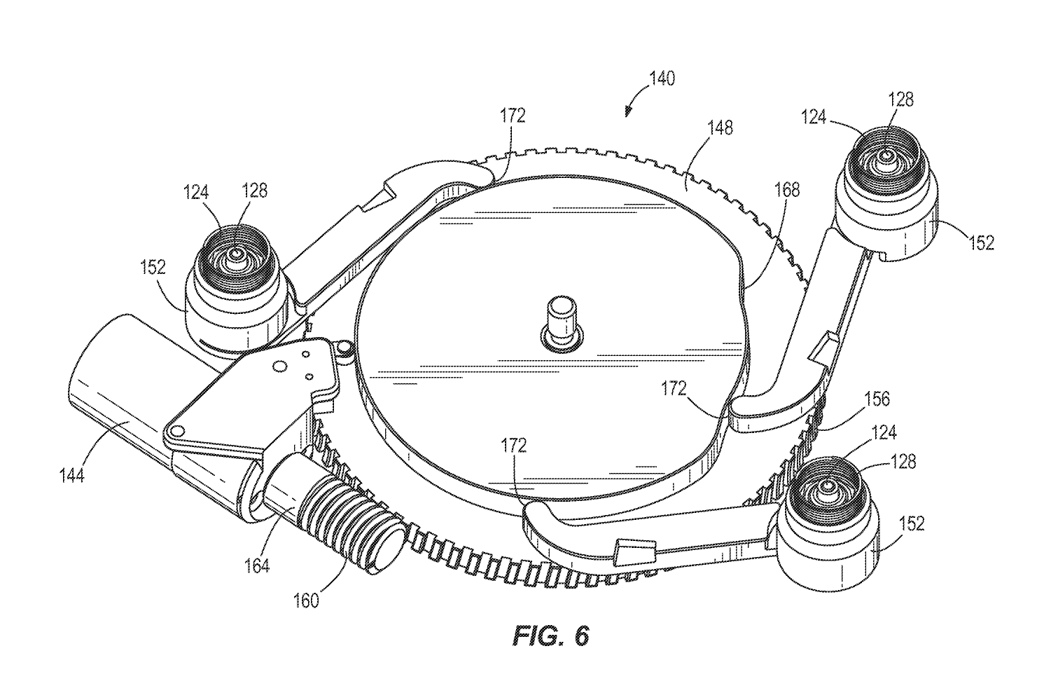

Referring to FIG. 6, the cam wheel 148 includes a circumferential cam surface 168 that engages cam followers 172 on each of the clamps 152 to impart rotation to the clamps 152 (FIG. 6). When the clamps 152 are rotated in a first direction (counter-clockwise in the orientation of FIG. 6), the clamps 152 tighten on to the pins 128 to lock the pins 128 relative to the base 104. When the clamps 152 are rotated in a second, opposite direction (clockwise in the orientation of FIG. 6), the clamps 152 release the pins 128, allowing the pins 128 to freely slide relative to the base 104 in the Z-direction. The clamps 152 can be biased in the second direction by one or more torsion bars, springs, or any other suitable arrangement (not shown).

In the illustrated embodiment, the cam surface 168 is profiled so that the individual clamps 152 can be tightened or loosened sequentially as the cam wheel 148 rotates. Alternatively, the locking mechanism 140 may include solenoids, servo motors, pneumatic or hydraulic cylinders, or any other actuators suitable for clamping and releasing the respective pins 128.

The support assembly 116 is operable to provide automatic tramming functionality for the build platform 108 to level the build surface 112 relative to the XY motion plane of the deposition nozzle 120. The steps described below can be fully automated and executed by a controller of the 3D printing system as an initialization routine prior to any new 3D printing operation. Alternatively any or all of the steps can be performed or controlled manually by a user of the 3D printing system.

With reference to FIGS. 4, 6, and 7, in order to perform the tramming operation for the illustrated and described embodiment, the deposition nozzle 120 is positioned directly above the build platform 108 at one of the support points (e.g., the first support point A). The clamp 152 at the first support point A is loosened (e.g., by energizing the motor 144 to rotate the cam wheel 148) allowing the pin 128 to slide freely relative to the base 104 such that the build platform 108 rests or floats on the spring 124 (FIGS. 4 and 6). The clamps 152 at the remaining two support points (e.g., support points B and C) may be either loose or clamped without affecting the tramming operation at the first support point A. Next, the nozzle 120 is lowered (i.e. moved in the negative Z-direction) until it contacts the build surface 112 (FIG. 7). The nozzle 120 continues to move downward, bearing against the build surface 112 to move the build platform 108 toward the base 104 against the biasing force of the spring 124. The nozzle 120 stops when it reaches Z′ (e.g., Z=0), corresponding with the desired first deposition layer elevation. The clamp 152 at the first support point A is then tightened (e.g., by energizing the motor 144 to rotate the cam wheel 148), locking the pin 128 in place. This fixes the elevation of the build surface 112 to Z′ at the first support point A.

Once the elevation of the build surface 112 is set to Z′ at the first support point A, the nozzle 120 moves away from the build surface 112 in the Z direction a sufficient distance so as to be completely clear of the build surface 112 in the XY plane. The nozzle 120 then moves into position direction above the build platform 108 at one of the remaining support points (e.g., the second support point B). The clamp 152 at the second support point B is loosened (e.g., by energizing the motor 144 to rotate the cam wheel 148) allowing the pin 128 to slide freely relative to the base 104 such that the build platform 108 rests or floats on the spring 124. The clamp 152 at the first support point A remains clamped to maintain the set elevation of the build surface 112 at the first support point A. The nozzle 120 is then lowered (i.e. moved in the negative Z-direction) until it contacts the build surface 112 above the second support point B. The nozzle 120 continues to move downward, bearing against the build surface 112 to move the build platform 108 toward the base 104 against the biasing force of the spring 124. The nozzle 120 stops when it reaches Z′, and the clamp 152 at the second support point B is tightened (e.g., by energizing the motor 144 to rotate the cam wheel 148), locking the pin 128 in place. This fixes the elevation of the build surface 112 to Z′ at the second support point B.

Once the elevation of the build surface 112 is set to Z′ at the first and second support points A, B, the nozzle 120 moves away from the build surface 112 in the Z direction a sufficient distance so as to be completely clear of the build surface 112 in the XY plane. The nozzle 120 then moves into position directly above the build platform 108 at the third and final support point C. The clamp 152 at the third support point C is loosened (e.g., by energizing the motor 144 to rotate the cam wheel 148) allowing the pin 128 to slide freely relative to the base 104 such that the build platform 108 rests or floats on the spring 124. The clamps 152 at the first and second support points A, B remain clamped to maintain the set elevation of the build surface 112 at Z′ at the first and second support points A, B. The nozzle 120 is then lowered (i.e. moved in the negative Z-direction) until it contacts the build surface 112 above the third support point C. The nozzle 120 continues to move downward, bearing against the build surface 112 to move the build platform 108 toward the base 104 against the biasing force of the spring 124. The nozzle 120 stops when it reaches Z′, and the clamp 152 at the third support point C is tightened (e.g., by energizing the motor 144 to rotate the cam wheel 148), locking the pin 128 in place. This fixes the elevation of the build surface 112 to Z′ at the third support point.

At the completion of this procedure, all of the support points A, B, C have been locked, fixing the build surface 112 at a known Z axis position (Z′). Because three points fully define a plane, fixing the build surface 112 at Z′ at each of the three support points A, B, C levels the build surface 112 relative to the XY motion plane of the nozzle 120. In addition, the elevation of the build surface 112 is equal to the contact point between the build surface 112 and the nozzle. All layering operations during a subsequent 3D printing process can now be performed with reference to this known build surface elevation Z′.

Thus, the invention provides an automated and efficient method for accurately leveling the build surface 112 relative to the XY movement plane of the deposition nozzle 120 and for establishing the build surface 112 as a known datum plane. The invention may be implemented on both new and existing 3D printing systems. Existing 3D printing systems may be modified simply by replacing the platform assembly with the platform assembly described above and by making minor alterations to the control subsystem.

Although the invention has been described in detail with reference to certain preferred embodiments, variations and modifications exist within the scope and spirit of one or more independent aspects of the invention as described. For example, although it is believed that the tramming operation is best performed with the nozzle directly above three support points, it is possible to perform the operation with the nozzle misaligned with the support points, and a different number of support points could be used. In addition, instead of tramming the build surface to be horizontal, the concepts of the present invention could also be used to establish a non-horizontal build surface.

Various features of the invention are set forth in the following claims.

What is claimed is:

1. A 3D printer comprising:
a base;
a build platform supported by the base;
an adjustable support assembly coupling the build platform to the base; and
a locking mechanism that secures a position of the build platform relative to the base.

2. A 3D printer as claimed in claim 1, wherein the adjustable support assembly comprises three resilient support points between the base and the platform.

3. A 3D printer as claimed in claim 1, wherein the adjustable support assembly comprises a resilient support point between the base and the platform.

4. A 3D printer as claimed in claim 3, wherein the locking mechanism is movable from an unlocked position, where the platform is movable relative to the base at the support point, and a locked position, where the platform in substantially inhibited from moving relative to the base at the support point.

5. A 3D printer as claimed in claim 3, wherein the resilient support point includes a compressible resilient member supporting the platform on the base.

6. A 3D printer as claimed in claim 5, wherein the resilient support point further includes a post extending between the platform and the base.

7. A 3D printer as claimed in claim 6, wherein the post includes a pivot to facilitate limited angular movement of the post relative to the platform.

8. A 3D printer as claimed in claim 6, wherein the locking mechanism includes a releasable clamp operatively positioned between the base and the post.

9. A method of tramming a build platform on a 3D printer, comprising:
resiliently supporting the platform on a base at a first support point;
pushing on a build surface of the platform to move the platform relative to the base at the first support point; and
locking a position of the platform relative to the base at the first support point after the pushing step.

10. A method as claimed in claim 9, wherein resiliently supporting includes positioning a spring between the base and the platform.

11. A method as claimed in claim 9, wherein pushing includes contacting a print head with the build surface.

12. A method as claimed in claim 11, wherein contacting includes engaging the print head with the build surface at a location substantially vertically aligned with the first support point.

13. A method as claimed in claim 11, wherein locking occurs with the print head in contact with the build surface.

14. A method as claimed in claim 9, further comprising, after the recited resiliently supporting, pushing, and locking steps associated with the first support point, repeating the resiliently supporting, pushing and locking steps at a second support point while maintaining the locked position of the platform relative to the base at the first support point.

15. A method as claimed in claim 14, wherein further comprising, after the recited resiliently supporting, pushing, and locking steps associated with the first and second support points, repeating the resiliently supporting, pushing and locking steps at a third support point while maintaining the locked position of the platform relative to the base at the first and second support points.
